(19) United States
(12) Patent Application Publication
(10) Pub. No.: US 2002/0111905 A1
(43) Pub. Date: Aug. 15, 2002

(54) Power demand and supply-adjustment system and method

(76) Inventors: Naoyuki Nagafuchi, Tokai (JP); Tooru Horie, Hitachiota (JP); Jin?apos;ichiro Gotoh, Hitachi (JP); Takeshi Ishida, Hitachi (JP); Hiroshi Haruyama, Hitachi (JP)

Correspondence Address: MATTINGLY, STANGER & MALUR, P.C., Suite 370, 1800 Diagonal Road, Alexandria, VA, 22314, US

(21) Appl. No.: 09/949,808

(22) Filed: Sep. 12, 2001

(30) Foreign Application Priority Data
Feb. 13, 2001 (JP) 2001-35675

(51) Int. Cl. G06F 17/60

(52) U.S. Cl. 705/40; 705/39

(57) ABSTRACT

A power consumption-demand/supply adjustment apparatus comprises: a monitor for a consumption amount of supplied power and the quality of supplied power; a contract-adjustment means for supporting establishing of contract for a power demand/supply by adjusting power demand conditions of a customer and power supply conditions of a power supplier; and banking means for requesting a charge of the consumption amount of supplied power and the quality of supplied power, and a charge to be paid from an accumulated deposit based on the contract; wherein the banking means requests the charge of supplied power and the charge to be paid from an accumulated deposit based on monitoring information sent from the monitor.

### BACKGROUND OF THE INVENTION

The present invention relates to a power demand and supply (demand/supply)-adjustment apparatus and method, and especially to a power demand and supply-adjustment apparatus and method which can implement stable power supplying.

Conventionally, it has been established that a power-management system in which power generation, transmission, and distribution facilities, which are arranged in a wide area, are managed. However, the introduction of various type competition principles, for example, non-regulation of power retailing, begins, and will become more popular. As an example, IPPs (Independent Power Producers), which power suppliers other than power companies, have been constructed, and perform to supply a definite amount of power.

In IPPs (Independent Power Producers), each IPP supplies power with different power supply conditions (power charge, the capacity of supplied power, a guaranteed limit of variation in power frequency, the repetition rate of instantaneous outages, a power loss time due to a periodical inspection, etc.) On the other hand, each customer desires power demand conditions such as a planned amount of consumption power, a planned power charge, power quality (a guaranteed limit of variation in supplied power frequency, the repetition rate of instantaneous outages, a power-receive stop due to a periodical inspection, etc.) However, there is not a system which implements a stable power supply so as to support an establishment of contract on a power demand and supply by adjusting differences between the demand conditions of a customer and the supply conditions of a power supplier. Further, a guarantee regulation rule applies if the quantity of supplied power is deteriorated, is not also established yet.

### SUMMARY OF THE INVENTION

The present invention has been achieved in consideration of the above described problems, and is aimed at providing a power consumption-supply apparatus and method, which can support to adjust differences between demand conditions of a customer and supply conditions of a supplier. can achieve stable power supplying corresponding wit demands of customers.

To achieve the above objective, the present invention provides the following means.

This means comprises: a monitor for the power consumption amount and quality, which has been sent from customers and suppliers; a contract-adjustment means for support to adjust differences between power demand conditions of each customer and power supply conditions of each suppliers; a banking means for requesting power charge and a deposit for payment according to the above adjusted contract; wherein the banking means requests payment of power consumption charge or a deposit for payment based on monitoring information sent from the monitor.

### BRIEF DESCRIPTION OF THE DRAWINGS

FIG. 1 is a schematic block diagram of a power supply system to which a power demand and supply-adjustment system of an embodiment according to the present invention.

FIG. 2 is a flow chart of operations of the contract-adjustment means.

FIG. 3 is a flow chart of operations of the banking means.

FIG. 4 is a schematic diagram more intimately showing the processing contents of step 32.

### DETAILED DESCRIPTION OF THE EMBODIMENTS

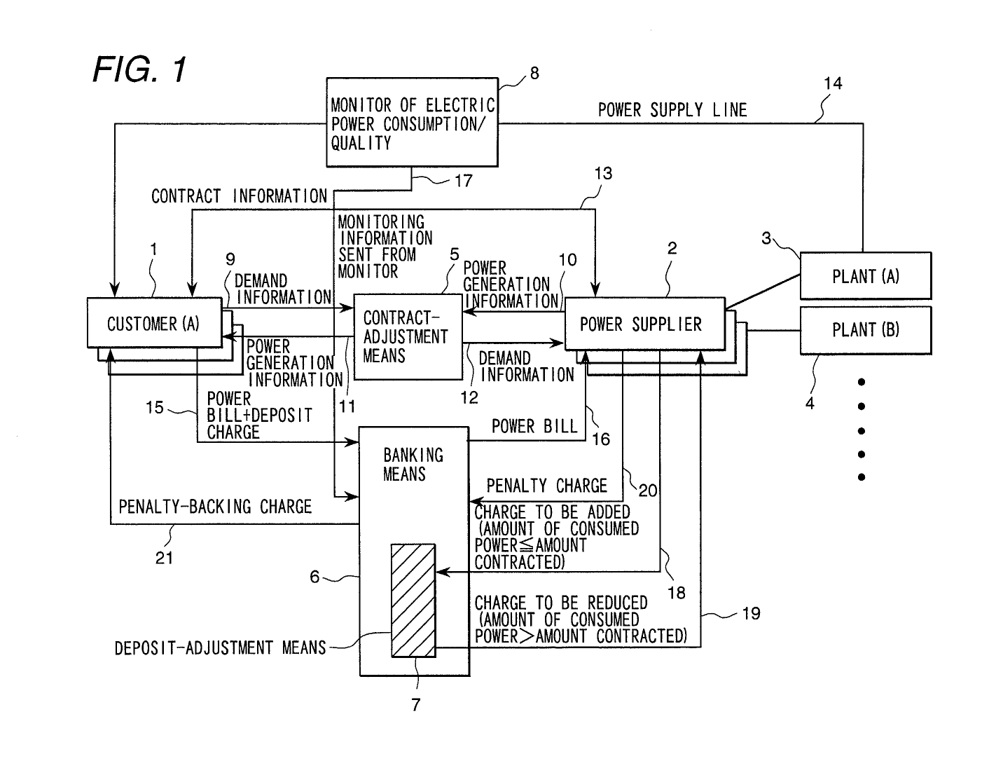

Hereafter, details of the embodiment according to the present invention will be explained with reference to FIG. 1-FIG. 4. FIG. 1 schematically shows the composition of a power supply system to which a power demand and supply-adjustment system of an embodiment according to the present invention is applied. In this figure, the power supply system includes: one or more customers 1; a plurality of power suppliers such as IPPS; power generation plants 3 and 4; the contract-adjustment means 5 for supporting to adjust differences between power demand conditions of each customer and power supply conditions of each supplier; a banking means 6 which processes payment and deposit-accumulation prepared for charge payment based on later-mentioned demand and supply contracts, and consumption power bills, a mentioned-later deposit-accumulation means 7 for accumulating deposits a monitor 8 for monitoring the consumption amount and quality of supplied power. Reference numbers 9 and 10 indicate demands information of the customers, sent to the power suppliers. That is, power demand conditions desired by the customers such as a planned consumption amount of power, a desired power consumption charge, and a necessary power quality (a guaranteed limit of variation in frequency of supplied power, the repetition rate of instantaneous outages, a power-receive stop time due to a periodical inspection, and so forth). Reference number 13 indicates a contract information agreed by both customers and suppliers. Reference number 14 indicates a line through which power is supplied to customers. Reference number 15 indicates the charge of consumed power and a deposit. Reference number 15 is the charge of power. Reference number 18 is the charge to be paid to the deposit-accumulation means 7 for accumulating deposits of the customers if the amount of consumed power is less than the contracted amount. Reference number 19 is the charge to be paid to the power suppliers from the customers. Meanwhile, each customer and each power supplier can be connected with a public line or an exclusive line.

Information 9 on demands required by a plurality of the customers 9, and information power generation information 10 from the power suppliers 2, are sent to the contract-adjustment means. The contract-adjustment means 5 sends; the received demand information 12 of the customers 1, and the received power generation information 11 of the power suppliers 2, to both the customers 1 and the suppliers. Further, The contract-adjustment means selects each pair of demand information of a customer and power generation information of a power suppliers, which are very near to each other. The result of the selection are sent to both the selected customer 1 and power supplier 2. Each selected pair of the customer 1 and the power supplier, whose the demand and the power information are near to each other. Further, while repeating exchanges between respective opinions on the demand of the customer 1 and the power suppliers 1 and the power generation conditions of the power supplier 2, contract respective conditions for both the sides are adjusted. If the adjustment has succeeded, the power supplier 2 supplies power from the power plants 3 and/or 4 to the customer 1 via the power line 1 in accordance with the above-established contract conditions. Moreover, a display means is provided to each of the contract-adjustment means 5, the customer 1, and the power supplier 2, and the power generation information, the demand information, and the information stored in the banking means, can be displayed on the display means.

At the power line 14, the monitor 8 is provided to monitor the power consuming state and the quality of supplied power, and also monitors the power generation information supplied from the power supplier 2. Further, the monitoring information is transmitted to the banking means 6.

The banking means 6 requests payment of the power charge and accumulation of a deposit according to the contract based on the received monitoring information of the power consumption amount and the quality of supplied power. Also, the banking means includes the deposit-accumulation means 7, and it accumulates deposits. Further, the banking means 6 pays the consumed power charge to the power supplier 2.

Moreover, the banking means 6 monitors the monitoring information sent from the monitor 8 concerning the consumption amount and the quality. If the consumption amount and the quality exceeds values determined in the contract, a part of deposit stored in the deposit-accumulation means 7 can be automatically paid to the power supplier 2. Conversely, If the consumption amount and the quality underruns the values determined in the contract, the charge corresponding to differences between the actual power consumption amount and the quality of supplied power and the contracted values is input to the banking means 6.

Further, if the contract cannot be attained by an accident, etc., which has occurred at the side of the power supplier 2, for example if the shortage of power to be supplied, or the frequency of power largely changes exceeding the guaranteed limit, the charge equivalent to the loss which the customer 1 has received is paid to the customer 1 via the banking means 6.

The data of above-described bill and payment are sent to the financial institutions designated in the contract, and is cleared up by exchanging the corresponding money between the designated financial institutions.

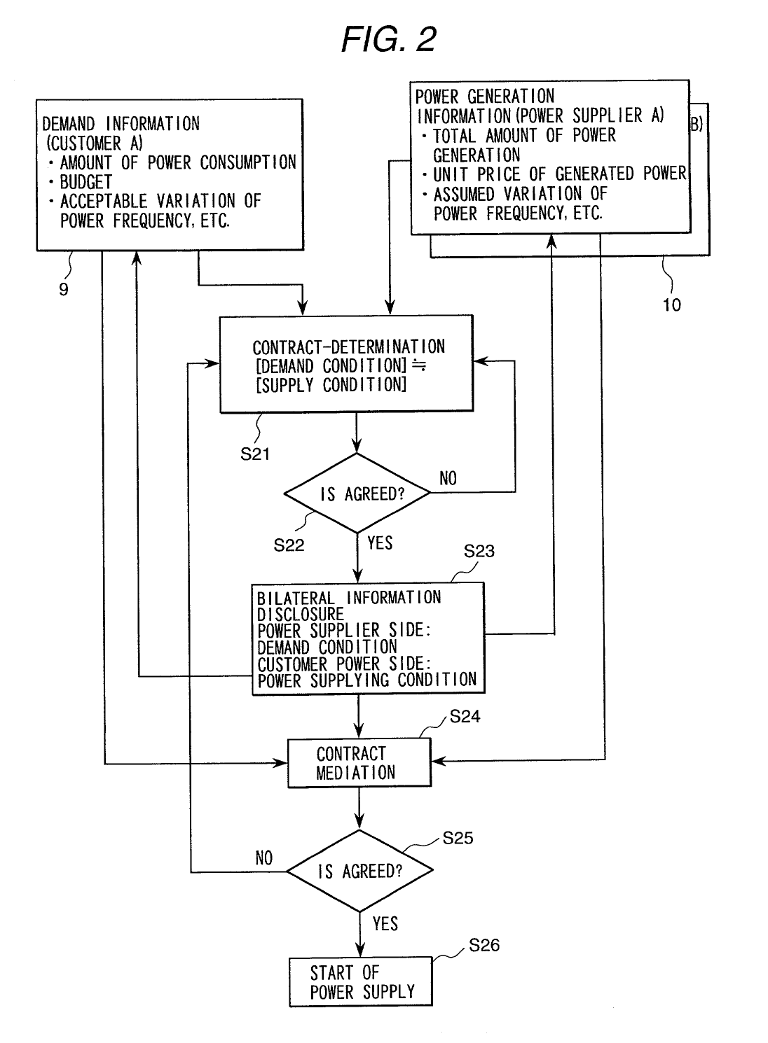

FIG. 2 shows a flow chart of operations of the contract-adjustment means 5. At first, in step 21, the contract-adjustment means 5 takes in the demand information 9 (an planned consumption power amount, an planned power charge, the necessary power quality, the guaranteed limit of variation in power frequency, etc.), which is required by the customer 1, and the power generation iformation (the toatal amount of generated power, a unit cost of power, the capacity of power supply, the guaranteed limit of variation in generated power frequency, the repetition rate of instantaneous power outages, information on the periodical inspection, etc.), and extracts and summarizes the power demand conditions of the customer 1 and the power generation conditions of the power supplier 2. In step 22, the degree of agreement of the extracted power demand conditions of the customer 1 and the extracted power supply conditions of the power supplier 2 is examined. If the degree of agreement is greatly large, processing goes back to step 23, otherwise, returns to step 21, and a new pair of a customer 1 having another power demand conditions and a supplier 2 having another power supply conditions is again input. In step 23, the extracted power supply conditions are sent to the new customer 1, and the extracted power demand conditions are sent to the new power supplier 2. In step 24, The contract-adjustment means 5 received answers on the respective demand/supply conditions from the customer 1 and the power supplier 2, respectively, Further, the contract-adjustment mean 5 mediates or adjust a contract of the demand conditions of the customer 1 and the supply conditions of the power supplier 2 based on the above answers received by the contract-adjust means. In step 25, it is determined whether or not a contract is established. If a contract is established, power supply is started, otherwise, processing goes back to step 21.

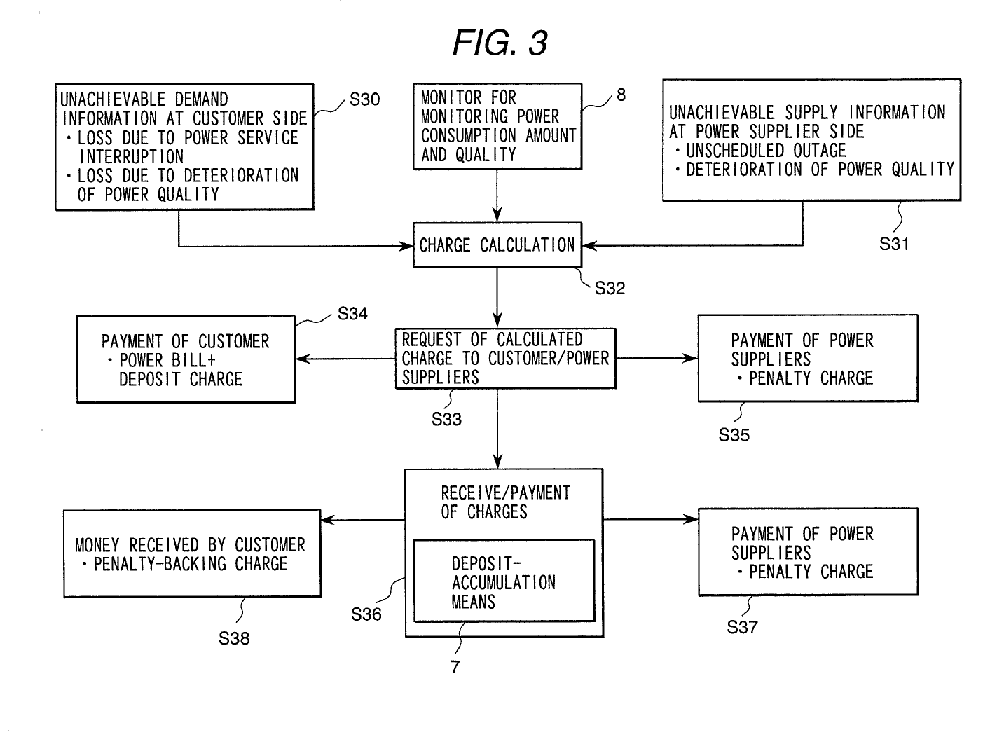

FIG. 3 shows a flow chart of operations of the banking means. At first, in step 30, from the customer 1, the banking means 6 takes in information on demand conditions which the customer 1 cannot attain (unachievable demand information), such as a break of contents in a database due to a power cut, a damage of disappearing of calculation results, a messy state occurring of contents in a data base due to the degradation of the power quality. Next, in step 31, the banking means 6 takes in, from the power supplier 2, information on power supply conditions which the power supplier 2 cannot attain (unachievable supply information), such as an unscheduled outage, the degradation of the power quality such as the decrease of power frequency, a large variation of power voltage, etc. Further, in step 32, the banking means 6 receives the required information sent from the customer 1 and the power supplier 2, on demand/supply which cannot be attained, the monitoring information from the monitor 8. This means calculates the charge to be received or paid by the customer 1/ the power supplier 2 based on the above-received information. In step 33, the calculated charge is informed. That is, in step 34, the power charge corresponding to the calculated consumed power and deposit to be input, and in step 35, the penalty charge due to the transit contract is informed.

In step 36, the banking means 6 executes the charge receive/payment process by using the deposit-accumulation /payment means included in the banking means 6. The charge receive/payment means includes the deposit-accumulation means 7, and calculates the charge to be input or paid by the customer 1/the power supplier 2. Further, in steps 37 and 38, the calculated charge is sent to the customer 1 and the power supplier 2. For example, if the consumption power amount of power and the quality of supplied power exceed the values of the contract, the charge receive/payment means reduces a part of the accumulated deposit by a charge corresponding to the amount exceeding the contract. Conversely, if the consumption amount of power and the quality of supplied power have underrun the contracted level, the charge corresponding to the difference between the resultant power consumption and the quality and the values of the contract is added to the deposit accumulated in the deposit-accumulation means 7. Furthermore, the charge receive/payment means can pay back a penalty charge to the customer 1 when a penalty charge must be paid back to the customer 1.

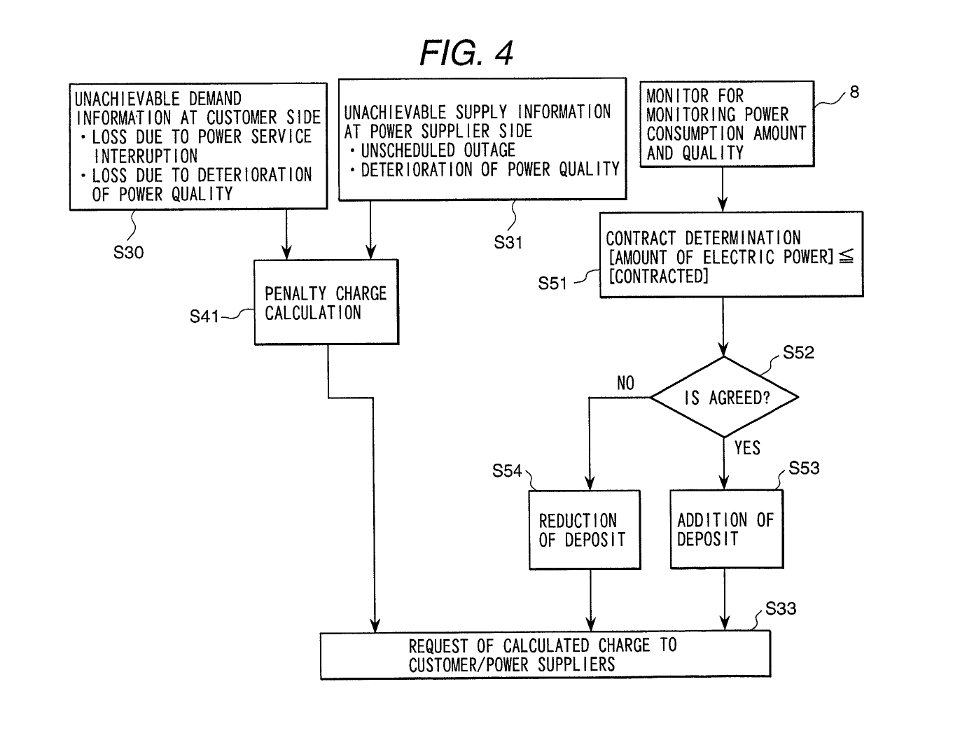

FIG. 4 shows a flow chart explaining in detail the contents of processing performed in step 32 in more detailed. At first, in step 30 and step 31,the charge receive/payment means takes in information from the customer 1 and power supplier 2, on contract conditions which the customer 1 and the power supplier cannot attain. In step 41, the penalty charge corresponding to the transit degree of the contract is calculated, and the processing goes to step 33. Also, in step 51, the consumption amount of power is taken in from the monitor 8, and in step 52, the take-in actual power consumption amount is compared with the contracted value. If [the actual power consumption amount]≦[the contracted value], the accumulated deposit in the deposit accumulated in the deposit-accumulation means 7 is increased by the charge corresponding to the difference between the above two amounts of power, otherwise, the processing goes to step 54. In step 54, the deposit accumulated in the deposit accumulated the deposit-accumulation means 7 is decreased by the charge corresponding to the difference [the actual power consumption amount]-[the contracted value].

As described above, according to the embodiments, it is possible to support an establishment of a contract of power demand/supply by selecting a power supplier which can implement power supply conditions most matching to power demand conditions required by a customer. The newly provided banking means automatically pays a power charge corresponding to the consumed power, a penalty charge, if the contract has not been carried out, and performs a deposit or a payment when a contracted amount of power has not been attained.

In accordance with the present invention, it has become possible to provide a power demand/supply adjustment apparatus and method which establishes a contract by adjusting demands conditions of a customer and power supply condition a power supplier.

What is claimed is:

1. A power consumption-demand/supply adjustment apparatus comprising:
a monitor for monitoring a consumption amount of supplied power and the quality of supplied power;
a contract-adjustment means for supporting establishment of a contract for a power demand/supply by adjusting differences between power demand conditions of a customer and power supply conditions of a power supplier; and
banking means for requesting a charge of said supplied power consumption amount of and the quality, and said charge to be paid from an accumulated deposit based on the contract;
wherein said banking means requests said charge of supplied power and said charge to be paid from an accumulated deposit based on monitoring information sent from said monitor.

2. A power consumption-demand/supply adjustment apparatus according to claim 1, wherein said banking means pays an excess charge from said accumulated deposit to said power supplier if said consumption amount of power exceeds a contracted amount.

3. A power consumption-demand/supply adjustment apparatus according to any one of claim 1 and claim 2, wherein, if said consumption amount of power underruns a contracted amount, the banking means pays a penalty charge corresponding to a difference between said consumption amount of power and said contracted amount.

4. A power consumption-demand/supply adjustment apparatus according to any one of claim 1 to claim 3, wherein, if said power supply conditions does not satisfy the conditions agreed in the power demand/supply contract, said banking means request a penal sum based on said contract.

5. A power consumption-demand/supply adjustment apparatus according to any one of claim 1 to claim 4, wherein said contract-adjustment means collects and stores power supply conditions information sent from a plurality of power suppliers and power demand condition information sent from a plurality of customers.

6. A power consumption-demand/supply adjustment apparatus comprising: charge calculation means for calculating a power charge based on power consumed; and charge determination means for determining a requested charge based on the quality of supplied power.

7. A power consumption-demand/supply adjustment apparatus comprising: power consumption means for inputting information power consumption amount; charge payment means for calculating a payment charge of each customer based on said power consumption amount and said power quality.

8. A method of adjusting power consumption-demand/supply adjustment apparatus comprising the step of:
calculating a payment charge based on said power consumption amount and quality.

9. A method of adjusting power consumption-demand/supply adjustment apparatus comprising the steps of:
comparing a power consumption amount with a contracted amount;
calculate power bill based on said power consumption amount if said power consumption amount does non exceed the contracted amount; and
calculate power bill based on said power consumption amount, and excess power bill based on an excess power consumption amount which has exceeded the contracted amount.

10. A method of adjusting power consumption-demand/supply adjustment apparatus comprising the steps of:
compare information on the quality of supplied power with the demand quality; and
calculate power bill based on said power consumption amount, and penalty power bill based on information on the quality of supplied power if the actual power quality underruns the demand quality.
